(19) United States
(12) Patent Application Publication
(10) Pub. No.: US 2026/0147255 A1
(43) Pub. Date: May 28, 2026

(54) CAMERA DEVICE

(71) Applicant: VIVOTEK INC., New Taipei City (TW)

(72) Inventors: Wei-Hung Chen, New Taipei City (TW); Ming-Wei Wang, New Taipei City (TW); Ping-Shu Wu, New Taipei City (TW)

(73) Assignee: VIVOTEK INC., New Taipei City (TW)

(21) Appl. No.: 19/369,365

(22) Filed: Oct. 27, 2025

(30) Foreign Application Priority Data
Nov. 27, 2024 (TW) 113145896

(51) Int. Cl. F21K 5/06

(52) U.S. Cl. CPC G03B 15/0442

(57) ABSTRACT

A camera device with a uniform illumination effect includes a base, a plurality of camera units, a light source and a covering component. The plurality of camera units is disposed on the base. The light source is located among the plurality of camera units. The covering component is disposed on the base to cover the plurality of camera units and the light source. The covering component includes a central area and an outer ring area. The outer ring area is disposed around the central area and corresponds to the plurality of camera units. The central area is integrally formed with the outer ring area and corresponds to the light source.

### BACKGROUND OF THE INVENTION

### 1. Field of the Invention

The present invention relates to a camera device, and more particularly, to a camera device with a uniform illumination effect.

### 2. Description of the Prior Art

A conventional camera device disposes a plurality of light sources around a camera unit to provide a wide illumination range for a surveillance region of the camera device. Although illumination angles of the plurality of light sources are partially overlapped, a dark area with low illumination brightness is still created in the center of the surveillance image. However, the center of the surveillance image is often considered as an important region of interest; if the brightness in the region of interest is low, subsequent image analysis may not be able to accurately identify content of the surveillance image. Therefore, design of a camera device with a uniform illumination effect is an important issue in the related surveillance industry.

### SUMMARY OF THE INVENTION

The present invention provides camera device with a uniform illumination effect for solving above drawbacks.

According to one embodiment, a camera device with a uniform illumination effect includes a base, a plurality of camera units, a light source and a covering component. The plurality of camera units is distributed on the base. The light source is located among the plurality of camera units. The covering component is disposed on the base and configured to cover the plurality of camera units and the light source. The covering component includes a central area and an outer ring area. The outer ring area is disposed around the central area and corresponds to the plurality of camera units. The central area is integrally formed with the outer ring area and corresponds to the light source.

The camera device of the present invention can dispose the light source among the plurality of camera units, and the camera unit and the light source can be completely covered by the covering component. The central area and the outer ring area of the covering component can be integrally formed to respectively correspond to the light source and the camera unit. The plurality of outer ring areas can be distributed around the central area in a symmetrical manner. The number and position of the outer ring areas can correspond to the number and position of the camera units. Based on relative configuration between the light source and the covering component, the covering component can optionally dispose the light sheltering portion adjacent to the light source for avoiding the beam from being projected onto the camera unit. The camera device can optionally dispose the optical lens adjacent to the light source, which is used to guide the beam from being away from the camera unit. The camera device of the present invention can concentrate an illumination range at the center of the surveillance image, and effectively prevent the camera unit from being interfered with the beam, thereby improving image quality of the surveillance image in the night mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded diagram of parts of a camera device according to a first embodiment of the present invention.

FIG. 2 is a sectional view of the camera device in an assembly status according to the first embodiment of the present invention.

FIG. 3 is an appearance diagram of the camera device according to the first embodiment of the present invention.

FIG. 4 is a sectional view of the camera device in the assembly status according to a second embodiment of the present invention.

FIG. 5 is a sectional view of the camera device in the assembly status according to a third embodiment of the present invention.

### DETAILED DESCRIPTION

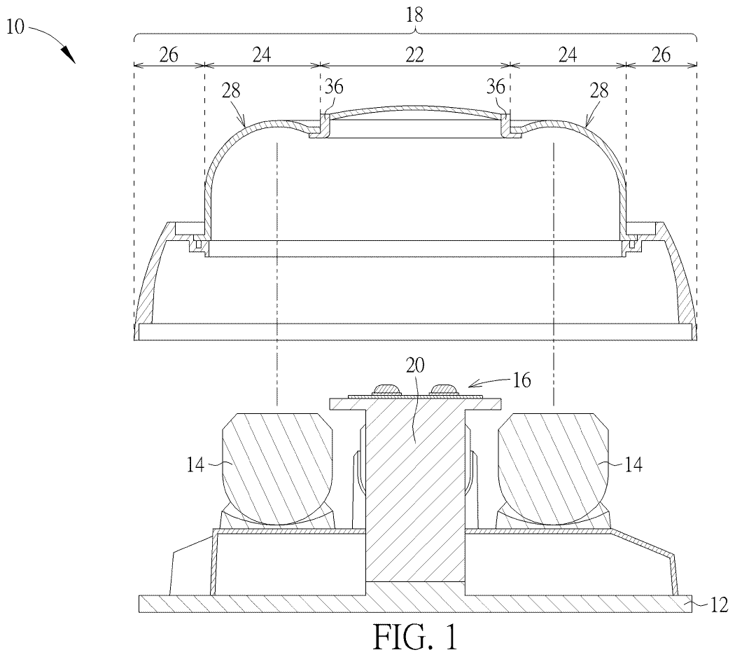

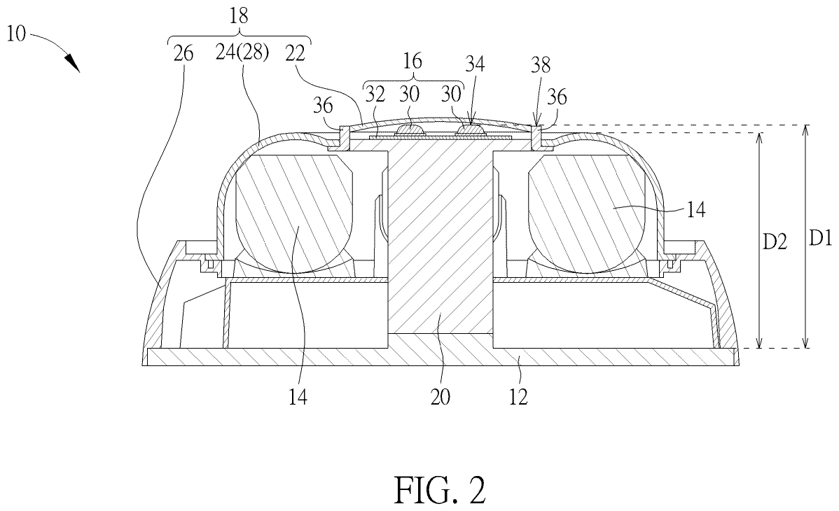

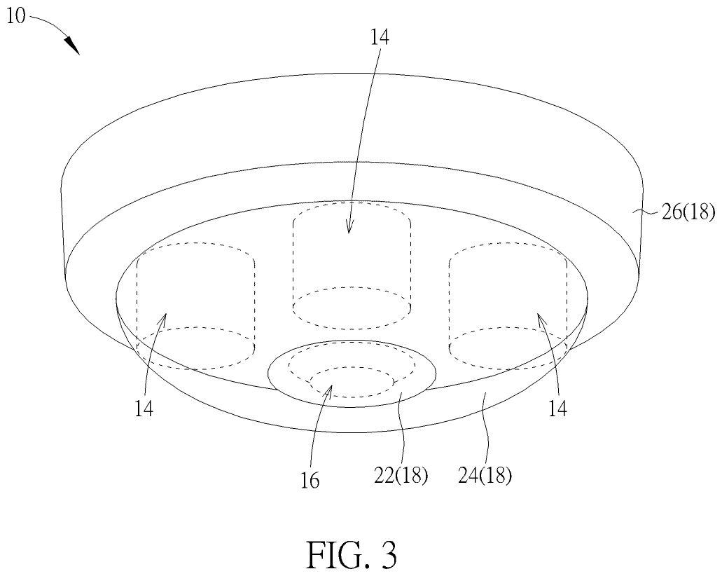

Please refer to FIG. 1 to FIG. 3. FIG. 1 is an exploded diagram of parts of a camera device 10 according to a first embodiment of the present invention. FIG. 2 is a sectional view of the camera device 10 in an assembly status according to the first embodiment of the present invention. FIG. 3 is an appearance diagram of the camera device 10 according to the first embodiment of the present invention. The camera device 10 can include a base 12, a camera unit 14, a light source 16 and a covering component 18. The camera unit 14 can be disposed on the base 12. A number and position of the camera unit 14 can depend on a design demand of the camera device 10, and a detailed description is omitted herein for simplicity. The light source 16 can be optionally disposed on a supporting portion 20 of the base 12, and located among the plurality of camera units 14. The light source 16 can provide illumination when the camera device 10 is switched into a night mode. The covering component 18 can be detachably disposed on the base 12, and used to cover the plurality of camera units 14 and the light source 16.

The covering component 18 can be entirely or partially made of transparent material. A beam emitted by the light source 16 can pass through the covering component 18 and be projected onto a target object. The camera unit 14 can shoot the target object to accordingly generate a surveillance image. The light source 16 can emit a visible light beam or an invisible light beam (e.g., Infra-red), which depends on an actual demand of the camera device 10. The target object can be the human, the vehicle, or any object, which depends on the actual demand of the camera device 10. In the present invention, the covering component 18 can include a central area 22, an outer ring area 24 and a case 26. Position of the case 26 can correspond to a lateral side of the camera unit 14, and the case 26 can be made of non-transparent material. The central area 22 and the outer ring area 24 can be made of transparent material. The outer ring area 24 can surround the central area 22 and correspond to the plurality of camera units 14. The central area 22 can be connected to the outer ring area 24 and correspond to the light source 16.

The central area 22 can be integrally formed with the outer ring area 24 to achieve the waterproof and dustproof effect. The central area 22 and the outer ring area 24 may be made of different materials. Double injection molding technology or other possible injection molding technology can be utilized to combine the central area 22 and the outer ring area 24 made of different materials; or, the central area 22 and the outer ring area 24 may be made of the same material, which depends on the design demand of the covering component 18. The outer ring area 24 can be optionally divided into a plurality of transparent covers 28 relative to the central area 22. Shapes of the plurality of transparent covers 28 can be symmetrical. Positions and sizes of the plurality of transparent covers 28 can align with and correspond to ones of the plurality of camera units 14. The light source 16 can include a light emitter 30 and a circuit board 32. The light emitter 30 can be disposed on the circuit board 32. The circuit board 32 can be located on a top end of the supporting portion 20.

In the present invention, a distance D1 between a light emitting surface 34 of the light source 16 and the base 12 can be preferably greater than a distance D2 between a top end of each transparent cover 28 and the base 12, which means a level height of the light source 16 can be slightly higher than a level height of the transparent cover 28. A light emitting direction of the light source 16 can be directed to a direction opposite to the camera unit 14, so as to prevent the camera unit 14 from being directly interfered with the light source 16. Besides, the covering component 18 can optionally include a light sheltering portion 36 located between the central area 22 and the outer ring area 24. The light sheltering portion 36 can be disposed adjacent to the circuit board 32, and a top end 38 of the light sheltering portion 36 can be parallel to or protrude from an upper surface of the circuit board 32. In a possible embodiment, the central area 22 and the outer ring area 24 of the covering component 18 can be designed as two arc-shaped structures. The top end 38 of the light sheltering portion 36 can align with or protrude from an external common tangent of the two arc-shaped structures (e.g., the central area 22 and the outer ring area 24), so as to block some light emitted by from the light source 16 from being transmitted towards the camera unit 14.

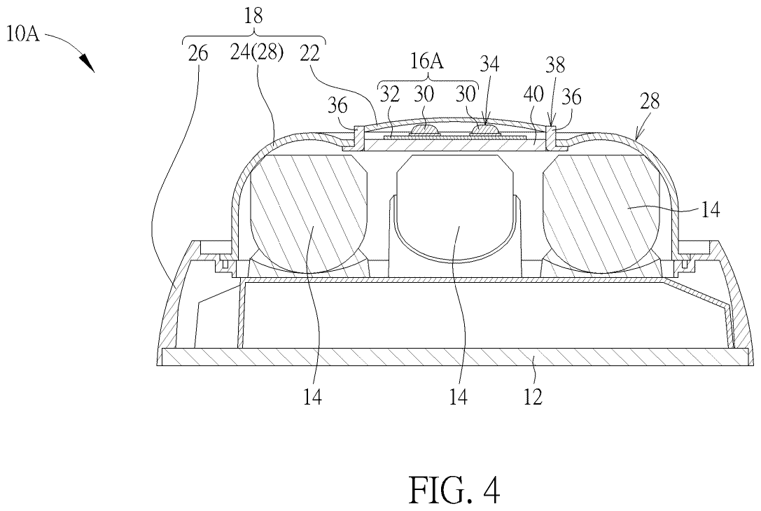

Please refer to FIG. 4. FIG. 4 is a sectional view of the camera device 10A in the assembly status according to a second embodiment of the present invention. In the second embodiment, elements having the same numerals as ones of the first embodiment have the same structures and functions, and the detailed description is omitted herein for simplicity. The camera device 10A can dispose an inner element 40 with a heat dissipating function inside the central area 22 of the covering component 18. The light source 16A can be disposed on the inner element 40 to align with the central area 22. Therefore, regardless of the light source 16A is disposed on the supporting portion 20 of the base 12 (which is matched with the first embodiment) or the inner element 40 of the covering component 18 (which is matched with the second embodiment), the light source 16A can be set on a middle of the plurality of camera units 14, and can provide uniform illumination effect to increase uniformity and brightness of the surveillance image in the night mode.

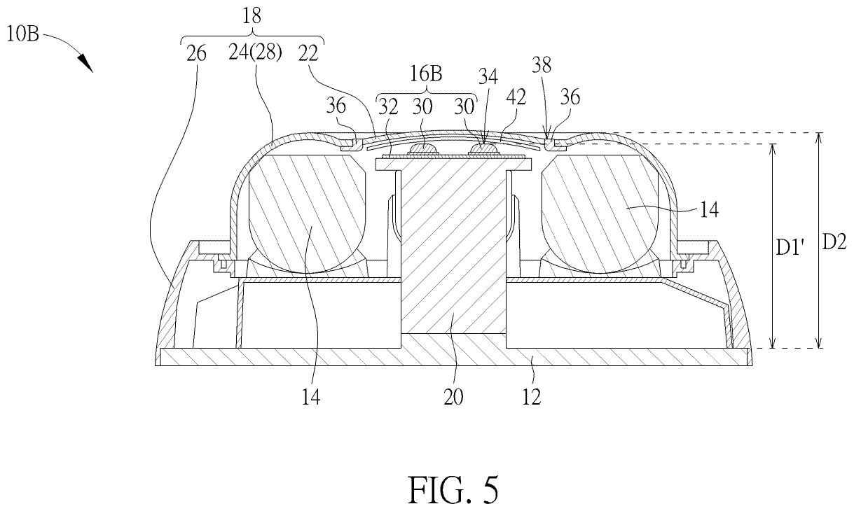

Please refer to FIG. 5. FIG. 5 is a sectional view of the camera device 10B in the assembly status according to a third embodiment of the present invention. In the third embodiment, elements having the same numerals as ones of the foresaid embodiments have the same structures and functions, and the detailed description is omitted herein for simplicity. The light source 16B of the camera device 10B may be disposed on the supporting portion 20 of the base 12, but an actual application is not limited thereto; the light source 16B may be disposed on the inner element 40 of the covering component 18, as shown in FIG. 4. In the third embodiment, the distance D1′ between the light emitting surface 34 of the light source 16B and the base 12 can be preferably smaller than or equal to the distance D2 between the top end of each transparent cover 28 and the base 12, so the level height of the light source 16B may be slightly lower than the level height of the transparent cover 28. Accordingly, the light sheltering portion 36 of the covering component 18 can be disposed adjacent to the circuit board 32, and the top end 38 of the light sheltering portion 36 can protrude from the upper surface of the circuit board 32. Or, the present invention may design the central area 22 and the outer ring area 24 of the covering component 18 as the arc-shaped structures. The top end 38 of the light sheltering portion 36 can align with or protrude from the external common tangent of the two arc-shaped structures (e.g., the central area 22 and the outer ring area 24).

Moreover, the camera device 10B can optionally include an optical lens 42 located on a side of the light source 16B opposite to the base 12, and used to change an optical transmission path of a beam emitted by the light source 16B. The optical lens 42 can be defined as a secondary optical structure, which can guide the beam emitted by the light source 16B to a specific direction, and prevent the beam from being projected onto the camera unit 14. That is to say, the camera device 10B of the third embodiment can dispose the light source 16B on position lower than the level height of the transparent cover 28, so as to avoid the central area 22 of the covering component 18 from being too prominent by comparing with the outer ring area 24, and the camera device 10B can have preferred appearance. The camera device 10B can dispose the light sheltering portion 36 between the central area 22 and the outer ring area 24 to block beam transmission, and can further utilize the optical lens 42 that corresponds to the light source 16B to guide the beam to project outwards. It should be mentioned that the optical lens 42 is not limited to be disposed on the camera device 10B of the third embodiment, and can be optionally disposed on the camera device 10 of the first embodiment and/or the camera device 10A of the second embodiment; change of the optical lens 42 can depend on the actual demand.

In conclusion, the camera device of the present invention can dispose the light source among the plurality of camera units, and the camera unit and the light source can be completely covered by the covering component. The central area and the outer ring area of the covering component can be integrally formed to respectively correspond to the light source and the camera unit. The plurality of outer ring areas can be distributed around the central area in a symmetrical manner. The number and position of the outer ring areas can correspond to the number and position of the camera units. Based on relative configuration between the light source and the covering component, the covering component can optionally dispose the light sheltering portion adjacent to the light source for avoiding the beam from being projected onto the camera unit. The camera device can optionally dispose the optical lens adjacent to the light source, which is used to guide the beam from being away from the camera unit. Comparing to the prior art, the camera device of the present invention can concentrate an illumination range at the center of the surveillance image, and effectively prevent the camera unit from being interfered with the beam, thereby improving image quality of the surveillance image in the night mode.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A camera device with a uniform illumination effect, the camera device comprising:
a base;
a plurality of camera units distributed on the base;
a light source located among the plurality of camera units; and
a covering component disposed on the base and configured to cover the plurality of camera units and the light source, the covering component comprising a central area and an outer ring area, the outer ring area being disposed around the central area and corresponding to the plurality of camera units, the central area being integrally formed with the outer ring area monolithically and corresponding to the light source.

2. The camera device of claim 1, wherein the light source is disposed on the base, or is disposed on an inner element of the covering component.

3. The camera device of claim 1, wherein the outer ring area is divided into a plurality of transparent covers relative to the central area, the shapes of the plurality of transparent covers are symmetrical and position of the plurality of transparent covers respectively align with the plurality of camera units.

4. The camera device of claim 3, wherein a distance between a light emitting surface of the light source and the base is greater than a distance between a top end of each transparent cover and the base.

5. The camera device of claim 3, wherein a distance between a light emitting surface of the light source and the base is smaller than or equal to a distance between a top end of each transparent cover and the base.

6. The camera device of claim 1, wherein the covering component further comprises a light sheltering portion located between the central area and the outer ring area.

7. The camera device of claim 6, wherein the light source comprises a light emitter and a circuit board, the light emitter is disposed on the circuit board, the light sheltering portion is located adjacent to the circuit board, a top end of the light sheltering portion is parallel to an upper surface of the circuit board or protrudes from the upper surface.

8. The camera device of claim 6, wherein the central area and the outer ring area are two arc-shaped structures, a top end of the light sheltering portion aligns with or protrudes from an external common tangent of the two arc-shaped structures.

9. The camera device of claim 5, wherein the camera device further comprises an optical lens located on a side of the light source opposite to the base, and adapted to change an optical transmission path of a beam emitted by the light source.
